(19) United States
(12) Patent Application Publication
(10) Pub. No.: US 2007/0252391 A1
(43) Pub. Date: Nov. 1, 2007

(54) Thermal wind power generator

(76) Inventor: Shih H. Chen, Yongkang City (TW)

Correspondence Address: HDSL, 4331 STEVENS BATTLE LANE, FAIRFAX, VA, 22033, US

(21) Appl. No.: 11/413,100

(22) Filed: Apr. 28, 2006

(51) Int. Cl. F03D 9/00

(52) U.S. Cl. 290/55

(57) ABSTRACT

A thermal wind power generator uses thermal wind of household chimney to generate electrical power. The thermal wind power generator includes a rectangular hood as main body and is arranged on a smoke outlet of a chimney. The hood includes a projected space of inverse funnel shape to collect thermal wind in the chimney. A wind opening is defined at center of the projected space and a blade is arranged at the opening. The blade is electrically connected to a power generator. The hot air flows upward and is collected into the hood to drive the blade. The mechanical momentum of the blade is sent to the power generator.

### BACKGROUND OF THE INVENTION

1. Field of the Invention

The present invention relates to a power generator, especially relates to a thermal wind power generator.

2. Description of Prior Art

Winter seasons have many holidays and festival for most countries and decorations are often used for many houses. For example, pumpkin lamps are often used in All holy days and Christmas trees are often used for Christmas holiday. In those decorations, lighting is essential elements.

For successful operation of those lightings, power supply is necessary. For indoor lightings, the power source can come from indoor power socket. However, for outdoor lightings, power extension cord is needed to conduct electrical power from indoor power socket. There are many commercially available power extension cords with different lengths and layouts. Moreover, power generator run by diesel is often used for providing power.

However, the use of power extension cord also meets some problem and risk. The excessively connected devices will cause instable electrical power or short circuit problem Moreover, the serially connected lightings will cause inefficient use of electrical power and the surcharge fee is a burden to user. The use of power generator run by diesel or gasoline will cause air pollution.

### SUMMARY OF THE INVENTION

The present invention is to provide a thermal wind power generator using thermal wind of household chimney to generate electrical power. The electrical energy can be generated with safety.

The thermal wind power generator includes a rectangular hood as main body and is arranged on a smoke outlet of a chimney. The hood includes a projected space of inverse funnel shape to collect thermal wind in the chimney. A wind opening is defined at center of the projected space and a blade is arranged at the opening. The blade is electrically connected to a power generator. The hot air flows upward and is collected into the hood to drive the blade. The mechanical momentum of the blade is sent to the power generator

Accordingly, the present invention provides a thermal wind power generator.

The thermal wind power generator includes a hood as main body and is arranged on a smoke outlet of a chimney. The hood includes a projected space to collect thermal wind in the chimney. A wind opening is defined at center of the projected space and a blade is arranged at the opening. The blade is electrically connected to a power generator. The hot air flows upward and is collected into the hood to drive the blade. The mechanical momentum of the blade is sent to the power generator

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the exploded view of the present invention

FIG. 2 shows the operation of the present invention.

FIG. 3 shows a preferred embodiment of the present invention.

FIG. 4 shows another preferred embodiment of the present invention.

FIG. 5 shows the hood according to another preferred embodiment of the present invention

FIG. 6 shows the way to fix the hood according to another preferred embodiment of the present invention.

### DETAILED DESCRIPTION OF THE INVENTION

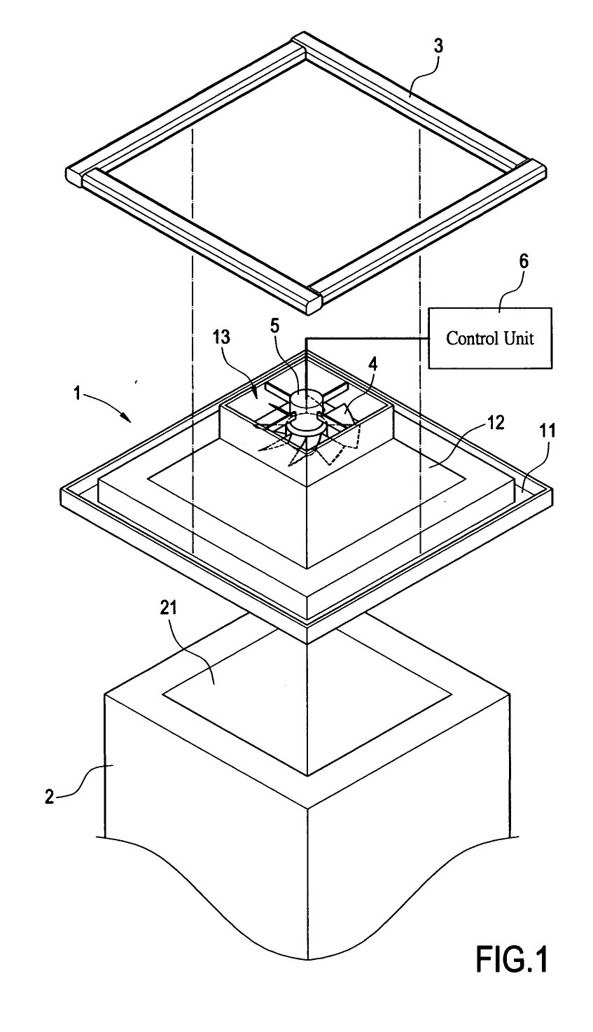

FIG. 1 shows the exploded view of the present invention. The thermal-wind power generator according to the present invention includes a hood 1 arranged on a smoke outlet 21 of a chimney 2. The hood 1 can be of rectangular shape and is adapted according to the shape of the smoke outlet 21 of the chimney 2. For example, the hood 1 can also be of round shape or ellipse shape. The hood 1 includes a surrounding groove 11 on peripheral thereof and a weight 3 in the surrounding groove 11. In the shown preferred embodiment, the weight 3 is an iron bar and the weight 3 will render the contact between the hood 1 and the smoke outlet 21 closer. A projected space 12 is defined at center of the hood land the projected space 12 is of inversed funnel shape to collect hot air in the chimney 2. A wind opening 13 is defined at center of the projected space 12 and the wind opening 13 includes a blade 4 with a front face facing the smoke outlet 21. The blade 4 is connected to a power generator 5 at topside thereof. The power generator 5 is electrically connected to a controller 6 for inputting a stable electrical power.

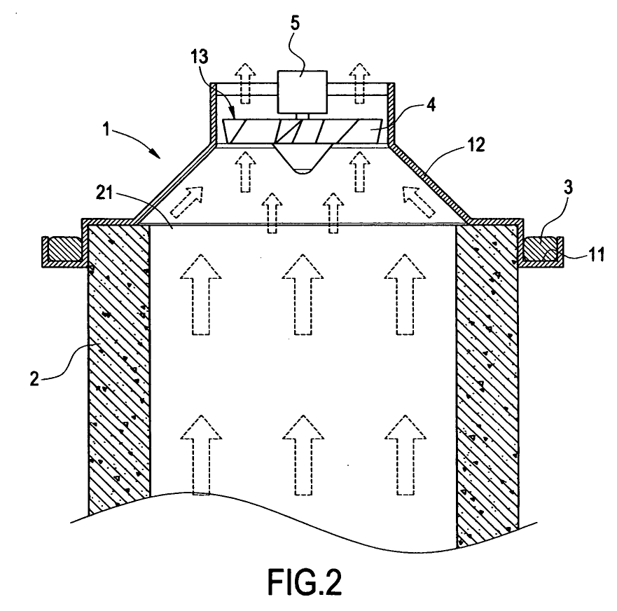

With reference to FIG. 2, when the hood 1 is completely arranged on the smoke outlet 21, the contact between the smoke outlet 21 and the hood 1 will be closer due to the weight 3. When user uses fireplace for warming in winter time, hot air is generated and flows out of house through the chimney 2. When the hot air flows to the smoke outlet 21, the hot air is collected due to the tunnel shape of the projected space 12. The movement speed of the hot air will be accelerated and the hot air moves to the wind opening 13. The hot air flowing out of the wind opening 13 will drive the blade 4 arranged on the wind opening 13. The mechanical momentum of the blade 4 will be transmitted to the power generator 5. The power generator 5 can be operated to generate electrical energy.

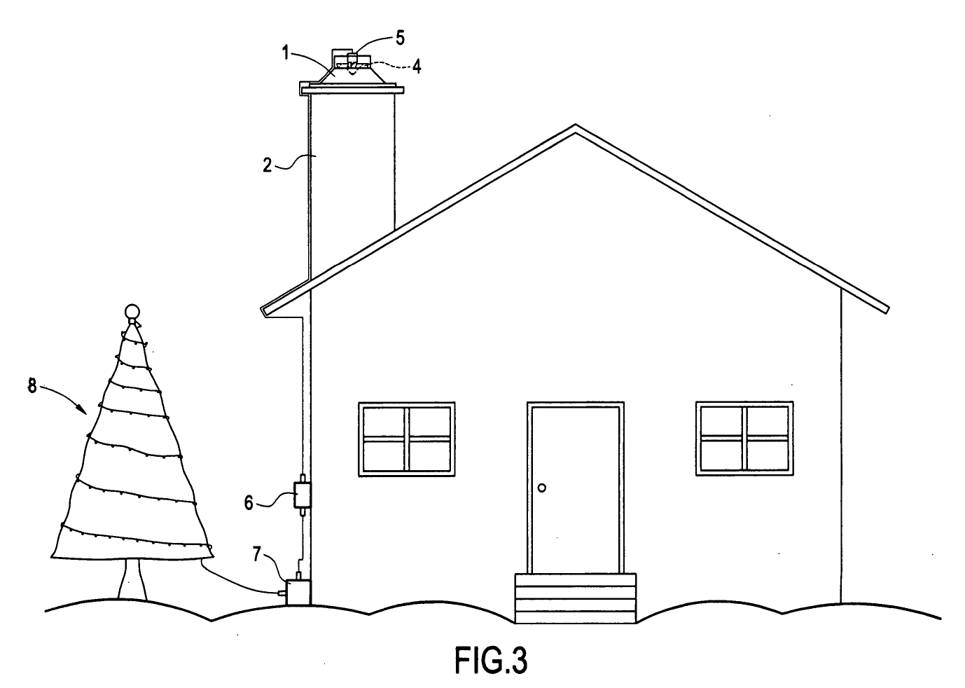

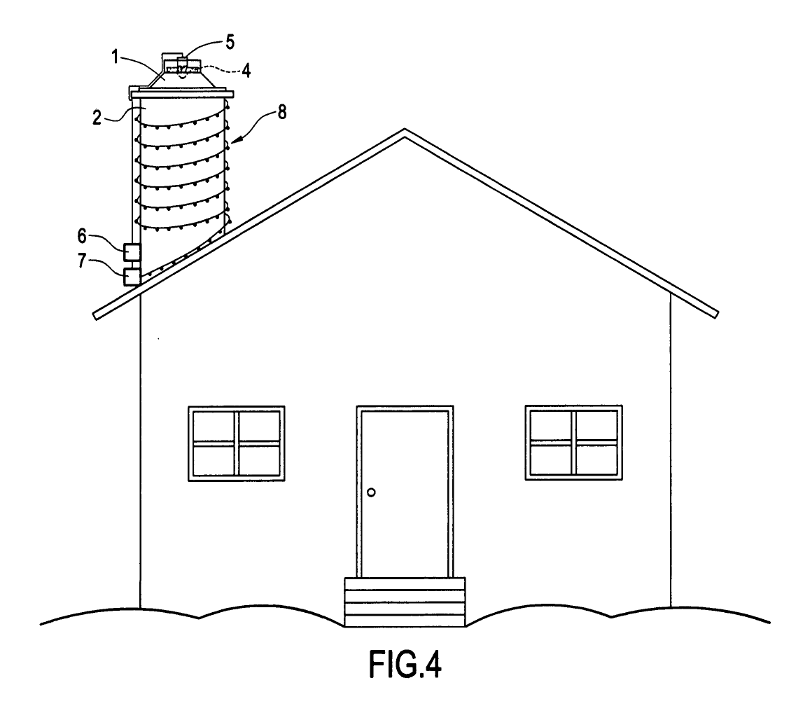

With reference to FIG. 3, the hood 1 is arranged on the smoke outlet 21 and the power generator 5 arranged atop the blade 4 is electrically connected to a controller 6 to stabilize the output DC power. The controller 6 is further electrically connected to a storage battery 7 to store an electrical energy in the storage battery 7. Afterward, a decoration article 8, such as a decorating lamp, is electrically connected to the storage battery 7. FIG. 4 shows another preferred embodiment of the present invention. When the hot air produced by the fire in the fireplace flows out along the chimney 2, the hot air will flow to the smoke outlet 21. When the hot air flows to the smoke outlet 21, the hot air is collected due to the tunnel shape of the projected space 12. The movement speed of the hot air will be accelerated and the hot air moves to the wind opening 13. The hot air flowing out of the wind opening 13 will drive the blade 4 arranged on the wind opening 13. The mechanical momentum of the blade 4 will be transmitted to the power generator 5. The power generator 5 can be operated to generate electrical energy. The electrically energy ca be sent to the storage battery 7 through the controller 6. The electrical energy can be supplied to the decoration article 8 and the excessive electrical energy is stored in the storage battery 7 for future use.

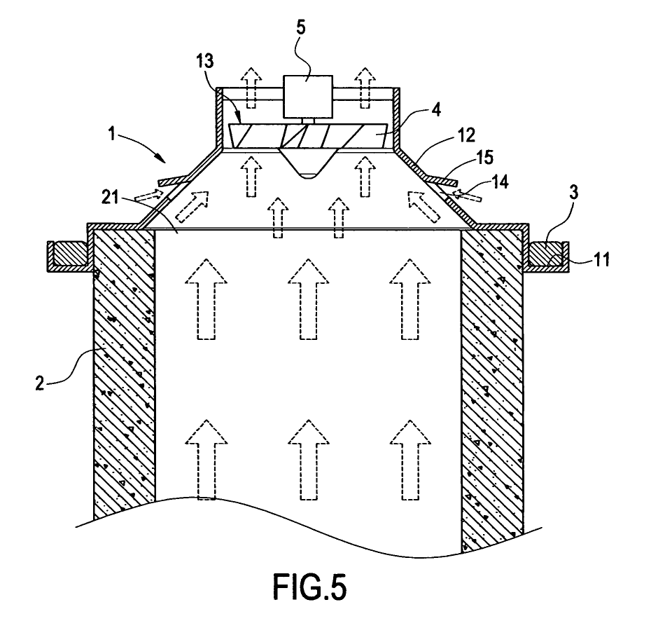

FIG. 5 shows another preferred embodiment of the present invention. At least one wind hole 14 is defined on the curved panel around the projected space 12. A baffle 15 is arranged atop the wind inlet 14. The baffle 15 can be freely bent, opened and closed. Therefore, external air can be introduced into the hood 1 by the provision of the wind inlet 14. The air amount in the hood 1 can be increased and the rotation of the blade 4 can be speeded up, thus enhancing the power generation efficiency of the power generator 5.

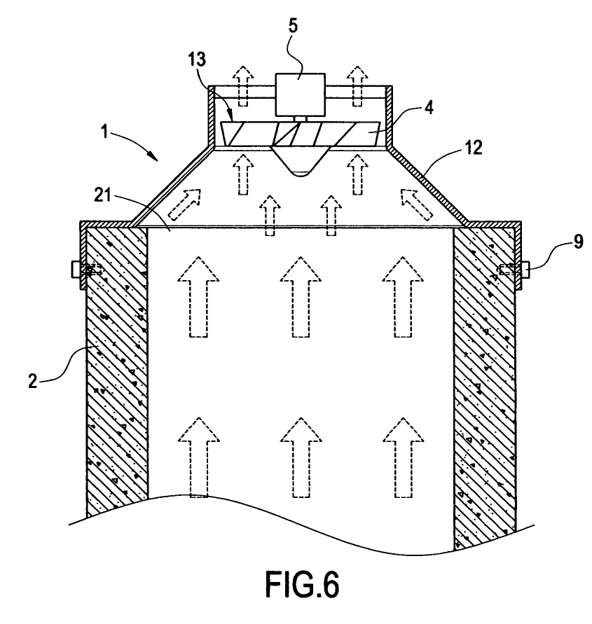

The hood 1 can be fixed by screw unit 9 such as screw or bolt besides being fixed by the weight 3. The hood 1 can be fixed to wall of the chimney 2 by screw unit 9 such as screw or bolt, as shown in FIG. 6.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A thermal wind power generator arranged on a chimney and comprising a hood arranged on the chimney and comprises a wind opening;
a blade arranged on the wind opening;
a power generator electrically connected to the blade.

2. The thermal wind power generator as in claim 1, wherein the hood comprises a projected space.

3. The thermal wind power generator as in claim 1, wherein a plurality of wind inlet is defined on a panel around the projected space.

4. The thermal wind power generator as in claim 3, wherein a baffle is arranged atop the wind inlet.

5. The thermal wind power generator as in claim 1, wherein a surrounding groove is defined around the hood.

6. The thermal wind power generator as in claim 5, wherein a weight is provided in the groove.

7. The thermal wind power generator as in claim 6, wherein the weight is iron block.

8. The thermal wind power generator as in claim 1, wherein the hood is fixed to a chimney by screw unit.

9. The thermal wind power generator as in claim 1, wherein the power generator is electrically connected to a controller.

10. The thermal wind power generator as in claim 1, wherein the thermal wind power generator is electrically connected to a storage battery.
